(19) United States
(12) Patent Application Publication
(10) Pub. No.: US 2008/0148001 A1
(43) Pub. Date: Jun. 19, 2008

(54) Virtual Secure On-Chip One Time Programming

(75) Inventors: Christian Gehrmann, Lund (SE); Martin Svenningsson, Lund (SE); Lennart Wegelid, Bjarred (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 11/611,130

(22) Filed: Dec. 14, 2006

(51) Int. Cl. G06F 13/14

(52) U.S. Cl. 711/164

(57) ABSTRACT

One time programming functionality is provided on an integrated circuit by receiving one time programmable (OTP) data from a source that is external to the integrated circuit. It is determined whether the received OTP data is authentic, and if so, the received OTP data is stored in a write-lockable memory device that is located on the integrated circuit. The write-lockable memory device is thereafter locked to prevent any further writing to the write-lockable memory device for so long as power is maintained to the integrated circuit. After locking the write-lockable memory device while power is maintained, the OTP data is retrieved from the write-lockable memory device whenever the OTP data is needed. A key used to authenticate the received OTP data is stored on the integrated circuit within a memory device configured to permit reading of the key only one time.

### BACKGROUND

The present invention relates to providing one time programming capability on an integrated circuit without using dedicated one-time-programmable memory on that integrated circuit.

For many types of programmable electronic equipment, there is a need to protect the equipment from illegal reprogramming. This is the case, for example, with mobile communications equipment (e.g., cellular telecommunications equipment), in which there is a need not only to ensure that only type approved software is running on the equipment, but also to provide secure locking mechanisms for sensitive information stored in the equipment (e.g., a secure Subscriber Information Module (SIM) Lock mechanism). One important ingredient in a system solution for protection against unauthorized reprogramming is the use of One Time Programmable (OTP) memory. As its name expresses, OTP memory is a type of memory device that permits a single recording of information into a memory area. OTP memories are nonvolatile (i.e., they retain their information even when powered off). Initially, an OTP is in an unprogrammed state. Then, there is a programming phase in which the memory bits are programmed (e.g., one by one or as an entire block in a single operation, the particular implementation being irrelevant to this discussion). Following the recording of the information (hereinafter referred to as “OTP data”), the OTP memory is locked by any one of several techniques that prevents any information from being written in that portion of memory. Often, the information cannot be erased once the OTP enters its “locked” state. In some implementations, erasing is permitted but only when applied to the entire block of memory bits; erasing cannot be selectively applied to individual memory locations.

OTP memory is useful in many types of applications. As just one of many possible examples, before mobile equipment is customized, it must be possible to store the equipment software into a nonvolatile memory (e.g., a flash memory device). Hence, there exists a vulnerable “virgin state”, that allows new software and parameters to be programmed into the equipment. It is, therefore, important to make sure that once the equipment has left the factory, it is not be possible to bring the equipment back to this “virgin” state in any uncontrolled manner as this would allow illegal reprogramming. An OTP memory is very useful for this purpose because its contents can be used to hold information that distinguishes equipment that has left the factory from equipment that has not. One can, for example, set a so-called production flag in the OTP memory once the equipment's customization is finalized. This flag then informs the equipment boot and loader software that the equipment is customized and that any reprogramming needs special authorization.

The software utilizing the OTP information is typically executed on a main processor of the equipment (e.g., the main baseband processor of mobile communication equipment, e.g., a mobile phone). This implies that the most secure OTP-based solution is a solution in which the OTP memory resides on the same integrated circuit—“chip”—(e.g., a baseband processor in a mobile phone) as the main processor, since this will make tampering of the OTP read functionality much more difficult. Unfortunately, it is not always possible to offer on-chip OTP memory due to a number of technical and cost limitations. Consequently the OTP memory must often be realized in an external hardware component. In such an arrangement, there is of necessity a communications link for conveying the OTP readout from the external hardware component to the main processor. This communications link exposes the OTP reading function to manipulations of the data transfer between the OTP memory and the baseband chip. Manipulated data can cause the equipment to appear to be back in its “virgin” state, and therefore susceptible to unauthorized reprogramming.

This threat can be considerably reduced by protecting the OTP read operations by cryptographic means. More specifically, the main processor can determine whether the data that it receives from the communications link between itself and the OTP memory is authentic by issuing a random (or pseudo-random) challenge word (RND) to the external hardware component at or about the time that it initiates a read operation from the OTP memory. The external hardware component reads the data from the OTP memory and uses an encryption procedure to derive a “Message Authentication Code” (MAC) from the OTP data, a previously stored secret key (K), and the random challenge word (RND). The generated MAC is then returned to the main processor along with the OTP data. The main processor, which also maintains a copy of the secret key K, uses the secret key K, the received OTP data, and the issued random challenge word (RND) to calculate a reference MAC′ value. If MAC′ equals the received MAC value, then the received OTP data is regarded as valid (i.e., it has not been tampered with).

In order to maintain its secrecy, the secret key, K, must be protected from unauthorized access at the external unit. In order to have a complete security solution, it is also necessary to protect the secret key, K, at the unit (e.g., the main processor) that reads the OTP content. For example, if this key were stored in clear text in a ROM on the same integrated circuit that houses the main processor, anyone (in an R&D environment, for example) would be able to dump the contents of this memory and thereby gain access to the secret key K.

There is therefore a need to solve this security problem.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in embodiments encompassing methods and/or apparatuses for providing one time programming functionality on an integrated circuit. Providing one time programming functionality on the integrated circuit comprises receiving one time programmable data from a source that is external to the integrated circuit, and determining whether the received one time programmable data is authentic. If it is determined that the received one time programmable data is authentic, then the received one time programmable data is stored in a write-lockable memory device that is located on the integrated circuit. The write-lockable memory device is thereafter locked to prevent any further writing to the write-lockable memory device for so long as power is maintained to the integrated circuit. From the moment of locking the write-lockable memory device onward for so long as power is maintained to the integrated circuit, the one time programmable data is retrieved from the write-lockable memory device whenever the one time programmable data is needed.

In another aspect, determining whether the received one time programmable data is authentic comprises making a challenge word available to a recipient that is external to the integrated circuit. A message authentication code is then received from the source that is external to the integrated circuit, and a key is retrieved from a key memory device located on the integrated circuit. The key and the message authentication code are used to determine whether the received one time programmable data is authentic.

In yet another aspect, after retrieving the key from the key memory device, the key memory device is locked to prevent any further reading of the key memory device for so long as power is maintained to the integrated circuit.

In still another aspect, the retrieved key is stored in another memory device on the integrated circuit for retrieval during a power-up procedure performed by the integrated circuit. This copy of the key can then be used by one or more one way functions or one or more pseudo-random functions to derive one or more other keys. The retrieved key can then be erased from the another memory device after the power-up procedure has no further use for the retrieved key.

In yet another aspect, the key is initially stored into the key memory device, wherein the key is different from a key stored in another key memory device of another integrated circuit. From that key there is derived a key for use in a peripheral device that includes the source that is external to the integrated circuit. For example, a unique key can be stored into each integrated circuit so that knowledge of one integrated circuit's key cannot be used to authenticate the one time programmable data received in another integrated circuit.

In still another aspect, the one time programmable data is used to determine whether it is possible to store program code into a memory located on the integrated circuit without additional authorization.

In yet another aspect, determining whether the received one time programmable data is authentic comprises making a challenge word available to a recipient that is external to the integrated circuit; and receiving a message authentication code from the source that is external to the integrated circuit. If the integrated circuit is operating in a non-debug mode, then a non-debug key is retrieved from a key memory device located on the integrated circuit. This non-debug key and the message authentication code are used to determine whether the received one time programmable data is authentic. However, if the integrated circuit is operating in a debug mode, then the key memory device is locked to prevent any further reading of the key memory device for so long as power is maintained to the integrated circuit operating in debug mode. In this case, a debug key is retrieved from another memory device located on the integrated circuit. The debug key and the message authentication code are then used to determine whether the received one time programmable data is authentic. In this way, unauthorized access to the non-debug key can be prevented when the integrated circuit is undergoing testing.

In still another aspect, if the integrated circuit is operating in a non-debug mode, then, after retrieving the non-debug key from the key memory device, the key memory device is locked to prevent any further reading of the key memory device for so long as power is maintained to the integrated circuit. Similarly, if the integrated circuit is operating in a debug mode, then, after retrieving the debug key from the key memory device, the key memory device is locked to prevent any further reading of the key memory device for so long as power is maintained to the integrated circuit.

### BRIEF DESCRIPTION OF THE DRAWINGS

The objects and advantages of the invention will be understood by reading the following detailed description in conjunction with the drawings in which:

FIG. 1 is a block diagram of an arrangement whereby an OTP memory is implemented in a peripheral unit that is external to an integrated circuit housing a main processor.

FIG. 2 is a block diagram of an integrated circuit 201 comprising elements for carrying out various aspects of the invention.

FIG. 3 is a flow chart of steps performed in carrying out various aspects of the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

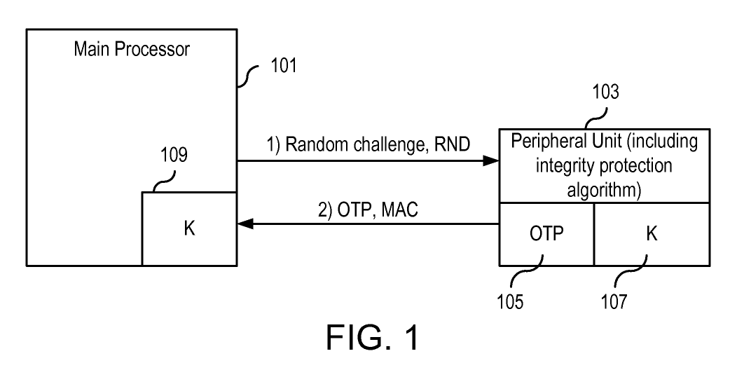

Aspects of the invention assume an authentication procedure as described in the Background section and as illustrated in FIG. 1, which is a block diagram of an exemplary arrangement whereby an OTP memory is implemented in a peripheral unit that is external to an integrated circuit that includes a main processor. Accordingly, an OTP read procedure includes a main processor 101 issuing a random challenge, RND, towards a peripheral unit 103 (step 1) that includes an OTP memory 105. The random challenge (RND), the OTP content and a secret key 107, K, shared between the unit with the main processor and the peripheral unit are used as inputs to an integrity protection algorithm. The OTP content together with a Message Authentication Code (MAC) from the integrity protection algorithm are then sent back to the main processor 101 (step 2). A MAC is a value generated as a function of a message (in this case, the OTP value read out from the peripheral unit's memory) and the secret key, K, stored in the peripheral unit 103. The main processor 101 checks the validity of the OTP value by determining whether the received integrity value (MAC) is what would have been expected based on its own copy of the secret key K 109 and its knowledge of the random challenge RND that was initially sent.

In order to perform the integrity check, the main processor 101 must have access to a copy of the secret key K 109. This is a potential security threat as this key must be exposed each time the OTP memory 105 in the external unit is read. In one aspect, embodiments of the invention eliminate this threat by using a procedure in which the OTP memory 105 is read only once, namely upon booting up of the main processor 101. At this time the main processor 101 will have access to the secret key K stored in a hardware protected memory. If the integrity check of the received OTP data indicates an authentic OTP value, then the main processor 101 stores the OTP content in an internal protected memory (e.g., an internal protected register) located on the same integrated circuit that includes the main processor 101. Once the OTP data is written into this memory/register, that memory/register is hardware protected from any further writing until a restart of the processor is initiated. Any security-critical software that needs to read the OTP content will thereafter read the OTP data from the internal protected memory/register instead of from the “real” OTP memory located in the peripheral unit. In this way a “virtual” OTP memory is provided on the main processor's integrated circuit without the need for actually implementing the OTP memory on that integrated circuit (which might be more expensive and cumbersome than having it on the peripheral unit).

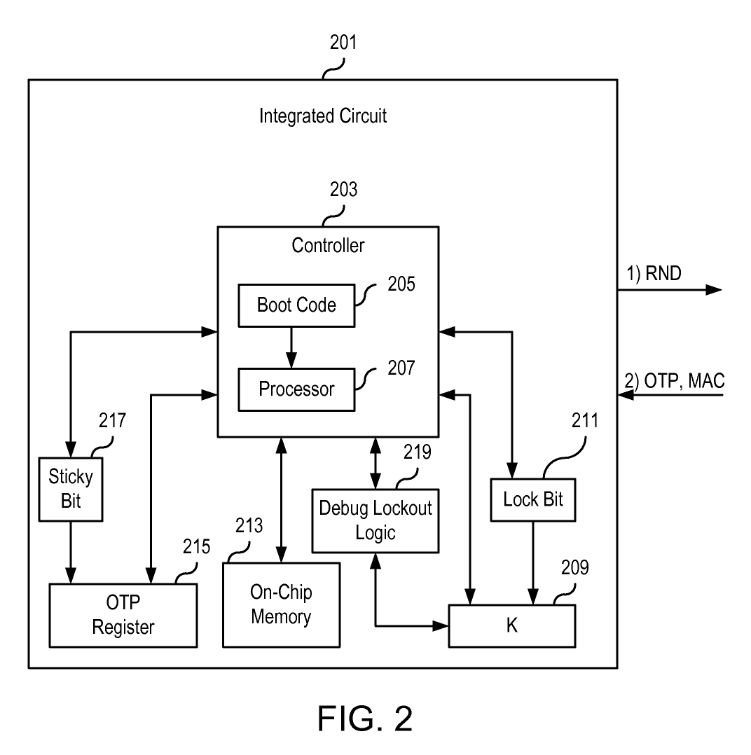

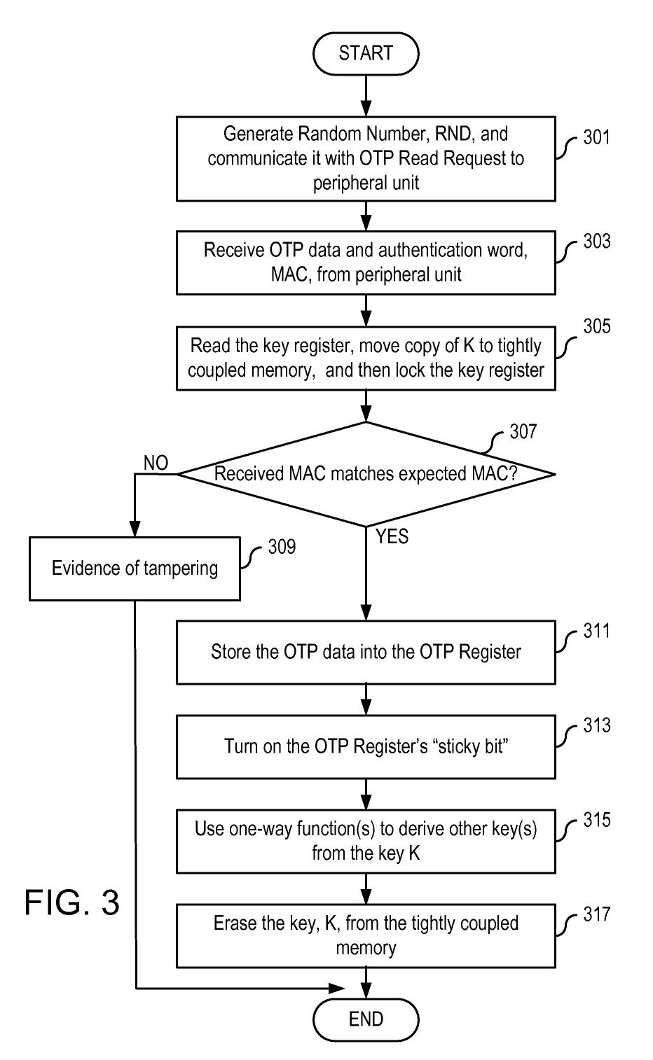

These and other aspects of the invention are now described in greater detail. FIG. 2 is a block diagram of an integrated circuit 201 comprising elements for carrying out various aspects of the invention. FIG. 3 is a flow chart of steps performed in carrying out various aspects of the invention. The steps of FIG. 3 may be performed, for example, by various elements depicted in FIG. 2 and described below.

The integrated circuit 201 includes a controller 203 capable of directing the various actions described herein. In the exemplary embodiment, the controller 203 is programmable and includes a set of program instructions (“boot code” 205) stored in a memory. The controller 203 further includes a processor 207 capable of carrying out the operations specified by the boot code 205. The boot code 205 is the set of program instructions that are performed upon initial power up of the device of which the integrated circuit 201 is a part.

One aspect of the power up procedure includes the integrated circuit 201 obtaining a copy of the OTP data stored in the peripheral unit 103. This involves generating a random number, RND and communicating this with an OTP memory read request to the peripheral unit 103 (step 301). In response to this action, the integrated circuit 201 receives the OTP data and a MAC (step 303).

The integrated circuit 201 needs to determine whether the received OTP data is authentic (i.e., that the received OTP data is an exact replica of the OTP data stored in the peripheral unit 103) and for this purpose it maintains a copy of the secret key, K, in a special key register (or other type of memory device) 209. The key register 209 is “special” in that it permits read operations to be performed only when a predetermined lock bit (or other code) is not asserted. The lock bit is stored in a lock bit register 211. Of course, some mechanism should be provided to prevent unauthorized changing of the contents of the lock bit register 211. For example, the lock bit register 211 can be constructed in such a way as to be self-locking; that is, once the lock bit is set, it locks not only the key register 209, but also the lock bit register 211 itself.

Accordingly, as part of the system boot operation (which is a protected execution routine—its execution, at least during non-debug modes of operation, cannot be taken over by means external to the code, such as unsolicited interrupts, (hardware) debug logic, and the like), the key register 209 is read and the key K is placed into an on-chip memory 213 (e.g., a tightly coupled memory, or any other memory that cannot be manipulated from outside the integrated circuit 201) (step 305). The value in the lock bit register 211 is changed so that the key register 209 will thereafter be unreadable so long as power is maintained to the integrated circuit 201.

The controller 203 then determines whether the received OTP data is authentic by, for example, ascertaining whether the received MAC matches the expected MAC (decision block 307). As mentioned earlier, the controller 203 knows the value of the random number, RND, and also has a copy of the secret key, K, stored in the on-chip memory 213. The controller 203 is therefore capable of determining an expected MAC value.

If the received MAC does not match the expected MAC value (“NO” path out of decision block 307), then the received OTP data cannot be considered authentic. Accordingly, the controller 203 will terminate the normal boot up procedure, and instead perform an application-specific routine associated with any evidence of tampering (step 309). The application-specific routine can, for example, take steps to prevent any further unauthorized actions, such as, but not limited to, erasing the key, K, from the on-chip memory 213.

However, if the received MAC matches the expected MAC value (“YES” path out of decision block 307) then the OTP data can be considered authentic. Accordingly, the received OTP data is stored into a write-lockable memory device (in this exemplary embodiment, the dedicated OTP register 215) that is located on the integrated circuit 201 (step 311). Associated with the OTP register 215 is a sticky bit 217 (e.g., an access right flag that can be assigned to files and directories). After the OTP data has been loaded into the OTP register 215, the controller 203 asserts the sticky bit 217 (step 313) which thereafter prevents any other value from being stored into the OTP register 215 except upon system reset. Any subsequent attempt to re-program the device will require accessing the OTP register 215 to obtain the OTP data, and so long as power is maintained to the device, that data is a valid representation of the data stored in the physical OTP memory 105. Thus, reprogramming will only be permitted if the OTP data obtained from the OTP register 215 indicates that the integrated circuit 201 is in its “virgin” state.

The boot code 205 can, at this point, use the key K (stored in the on-chip memory 213) to derive one or more other keys that can be used by other software modules needing to protect chip data or other content (e.g., to encrypt software to be loaded into a flash memory of a device utilizing the integrated circuit 201) (step 315). These other keys can be stored on the integrated circuit 201, for example in the on-chip memory 213. In order to protect the secrecy of the key K (i.e., to make it extremely difficult if not impossible to derive the value of the original key K from the one or more derived keys), one way function(s), pseudo-random function(s), and/or the like should be used to derive these other keys. Techniques are known in the art for deriving keys from a key K in such a way that an inverse process cannot be performed to obtain the original key K. A full discussion of such techniques is beyond the scope of the invention. The process taking care of any key derived from the original key K must make sure that the derived key is handled in a secure way and that the key(s) are erased once they are used.

Following the step of deriving any other required keys, the key K is no longer needed for so long as the integrated circuit 201 remains powered on. Therefore, in order to prevent any unauthorized access, the controller 203 erases the key K from the on-chip memory 213 (step 317). Consequently, the key K will never (i.e., so long as the integrated circuit remains powered on) be exposed to any other software running in the integrated circuit.

In another aspect, some embodiments of the invention prevent the key K from being exposed in the development and research environment. This is accomplished by using a different “debug key” instead of the “non-debug” key K for debugging and testing purposes. The “debug key” does not need to be stored in a hardware protected memory. In order to protect the non-debug key K in the debug circuit, any read out of the non-debug key K from the key register 209 is prevented by hardware when the circuit operates in debug or test mode (e.g., debug or external boot). The debug lockout logic 219 illustrated in FIG. 2 performs this function. The controller 203 provides information to the debug lockout logic 219 indicating the mode of operation (e.g., debug or external boot) of the integrated circuit 201.

In yet another aspect, some embodiments of the invention further limit the unauthorized used of the key K by utilizing different keys in different integrated circuits 201. For example, in an integrated circuit for use in a mobile communications device, each integrated circuit can have a unique key stored in its key register 209. At the time of customization, the secret key 107 stored in the peripheral unit 103 is then derived from the same unique key stored in the “main” integrated circuit. As used herein, the term “derived” includes, but is not limited to, using an identical key. This has the advantage of creating a unique pairing between the “main” integrated circuit and the peripheral unit. Thus, even if the key from one device falls into the wrong hands, that key cannot be used to enable any unauthorized programming (or other use) of other devices. It also prevents a peripheral device from working with the “main” integrated circuit.

Various aspects of embodiments of the invention provide a secure solution for maintaining OTP data in a manner that provides a virtual OTP memory on the integrated circuit 201 without the need for actual OTP memory hardware on the integrated circuit 201. Furthermore, various embodiments provide a secure derivation of a common key that can be used to protect additional data without the need for additional hardware storage of this key.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of providing one time programming functionality on an integrated circuit, the method comprising:
receiving one time programmable data from a source that is external to the integrated circuit;
determining whether the received one time programmable data is authentic;
in response to determining that the received one time programmable data is authentic, storing the received one time programmable data in a write-lockable memory device that is located on the integrated circuit, and thereafter locking the write-lockable memory device to prevent any further writing to the write-lockable memory device for so long as power is maintained to the integrated circuit; and
from the moment of locking the write-lockable memory device onward for so long as power is maintained to the integrated circuit, retrieving the one time programmable data from the write-lockable memory device whenever the one time programmable data is needed.

2. The method of claim 1, wherein determining whether the received one time programmable data is authentic comprises:
making a challenge word available to a recipient that is external to the integrated circuit;
receiving a message authentication code from the source that is external to the integrated circuit;
retrieving a key from a key memory device located on the integrated circuit; and
using the key and the message authentication code to determine whether the received one time programmable data is authentic.

3. The method of claim 2, comprising:
after retrieving the key from the key memory device, locking the key memory device to prevent any further reading of the key memory device for so long as power is maintained to the integrated circuit.

4. The method of claim 3, comprising storing the retrieved key in another memory device on the integrated circuit for retrieval during a power-up procedure performed by the integrated circuit.

5. The method of claim 4, comprising using one or more one way functions or one or more pseudo-random functions to derive one or more other keys from the retrieved key stored in said another memory device.

6. The method of claim 4, comprising erasing the retrieved key from said another memory device after the power-up procedure has no further use for the retrieved key.

7. The method of claim 2, comprising:
initially storing the key into the key memory device, wherein the key is different from a key stored in another key memory device of another integrated circuit; and
deriving from the key, a key for use in a peripheral device that includes the source that is external to the integrated circuit.

8. The method of claim 1, comprising:
using the one time programmable data to determine whether it is possible to store program code into a memory located on the integrated circuit without additional authorization.

9. The method of claim 1, wherein determining whether the received one time programmable data is authentic comprises:
making a challenge word available to a recipient that is external to the integrated circuit;
receiving a message authentication code from the source that is external to the integrated circuit;
if the integrated circuit is operating in a non-debug mode, then:
retrieving a non-debug key from a key memory device located on the integrated circuit; and
using the non-debug key and the message authentication code to determine whether the received one time programmable data is authentic; and
if the integrated circuit is operating in a debug mode, then:
locking the key memory device to prevent any further reading of the key memory device for so long as power is maintained to the integrated circuit operating in debug mode;
retrieving a debug key from another memory device located on the integrated circuit; and
using the debug key and the message authentication code to determine whether the received one time programmable data is authentic.

10. The method of claim 9, comprising:
if the integrated circuit is operating in a non-debug mode, then:
after retrieving the non-debug key from the key memory device, locking the key memory device to prevent any further reading of the key memory device for so long as power is maintained to the integrated circuit; and
if the integrated circuit is operating in a debug mode, then:
after retrieving the debug key from the key memory device, locking the key memory device to prevent any further reading of the key memory device for so long as power is maintained to the integrated circuit.

11. An apparatus for providing one time programming functionality on an integrated circuit, the apparatus comprising:
logic that receives one time programmable data from a source that is external to the integrated circuit;
logic that determines whether the received one time programmable data is authentic;
logic that, in response to determining that the received one time programmable data is authentic, stores the received one time programmable data in a write-lockable memory device that is located on the integrated circuit, and thereafter locks the write-lockable memory device to prevent any further writing to the write-lockable memory device for so long as power is maintained to the integrated circuit; and
logic that, from the moment of locking the write-lockable memory device onward for so long as power is maintained to the integrated circuit, retrieves the one time programmable data from the write-lockable memory device whenever the one time programmable data is needed.

12. The apparatus of claim 11, wherein the logic that determines whether the received one time programmable data is authentic comprises:
logic that makes a challenge word available to a recipient that is external to the integrated circuit;
logic that receives a message authentication code from the source that is external to the integrated circuit;
logic that retrieves a key from a key memory device located on the integrated circuit; and
logic that uses the key and the message authentication code to determine whether the received one time programmable data is authentic.

13. The apparatus of claim 12, comprising:
logic that, after the key is retrieved from the key memory device, locks the key memory device to prevent any further reading of the key memory device for so long as power is maintained to the integrated circuit.

14. The apparatus of claim 13, comprising logic that stores the retrieved key in another memory device on the integrated circuit for retrieval during a power-up procedure performed by the integrated circuit.

15. The apparatus of claim 14, comprising logic that uses one or more one way functions or one or more pseudo-random functions to derive one or more other keys from the retrieved key stored in said another memory device.

16. The apparatus of claim 14, comprising logic that erases the retrieved key from said another memory device after the power-up procedure has no further use for the retrieved key.

17. The apparatus of claim 12, comprising:
logic that initially stores the key into the key memory device, wherein the key is different from a key stored in another key memory device of another integrated circuit; and
logic that derives from the key, a key for use in a peripheral device that includes the source that is external to the integrated circuit.

18. The apparatus of claim 11, comprising logic that uses the one time programmable data to determine whether it is possible to store program code into a memory located on the integrated circuit without additional authorization.

19. The apparatus of claim 11, wherein the logic that determines whether the received one time programmable data is authentic comprises:
logic that makes a challenge word available to a recipient that is external to the integrated circuit;
logic that receives a message authentication code from the source that is external to the integrated circuit;
logic that, if the integrated circuit is not operating in a debug mode, performs:
retrieving a non-debug key from a key memory device located on the integrated circuit; and
using the non-debug key and the message authentication code to determine whether the received one time programmable data is authentic; and
logic that, if the integrated circuit is operating in a debug mode, performs:
locking the key memory device to prevent any further reading of the key memory device for so long as power is maintained to the integrated circuit operating in debug mode;
retrieving a debug key from another memory device located on the integrated circuit; and
using the debug key and the message authentication code to determine whether the received one time programmable data is authentic.

20. The apparatus of claim 19, comprising:
logic that, if the integrated circuit is operating in a non-debug mode, performs:
after retrieving the non-debug key from the key memory device, locking the key memory device to prevent any further reading of the key memory device for so long as power is maintained to the integrated circuit; and
logic that, if the integrated circuit is operating in a debug mode, performs:
after retrieving the debug key from the key memory device, locking the key memory device to prevent any further reading of the key memory device for so long as power is maintained to the integrated circuit.
